(19) United States
(12) Patent Application Publication
(10) Pub. No.: US 2007/0019107 A1
(43) Pub. Date: Jan. 25, 2007

(54) Robust de-interlacing of video signals

(75) Inventors: Gerard De Haan, Eindhoven (NL); Calina Ciuhu, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,237

(22) PCT Filed: Aug. 25, 2004
(86) PCT No.: PCT/IB04/51560

§ 371 Date: Feb. 28, 2006

(30) Foreign Application Priority Data
Sep. 4, 2003 (EP) 03103291.5

(51) Int. Cl. H04N 7/01

(52) U.S. Cl. 348/452

(57) ABSTRACT

The invention relates to an interpolating filter with coefficients that depend on the motion vector value, which uses samples that exist in the current field and additional samples from a neighboring field shifted over a part of a motion vector. Using samples from the current field and the motion compensated previous field that are not for vectors on a vertical line, the robustness of the de-interlacing may be increased. The interpolation quality may be better without increasing the number of input pixels.

The invention relates to a method for de-interlacing, in particular GST-based de-interlacing a video signal with estimating a motion vector for pixels from said video signal, defining a current field of input pixels from said video signal to be used for calculating an interpolated output pixel, and calculating an interpolated output pixel from a weighted sum of said input pixels. The invention further relates to a display device and a computer program for de-interlacing a video signal.

De-interlacing is the primary resolution determination of high-end video display systems to which important emerging non-linear scaling techniques such as DRC and Pixel Plus, can only add finer detail. With the advent of new technologies like LCD and PDP, the limitation in the image resolution is no longer in the display device itself, but rather in the source or transmission system. At the same time these displays require a progressively scanned video input. Therefore, high quality de-interlacing is an important pre-requisite for superior image quality in such display devices.

A first step to de-interlacing is known from P. Delonge, et al., “Improved Interpolation, Motion Estimation and Compensation for Interlaced Pictures”, IEEE Tr. on Im. Proc., Vol. 3, no. 5, Sep. 1994, pp 482-491.

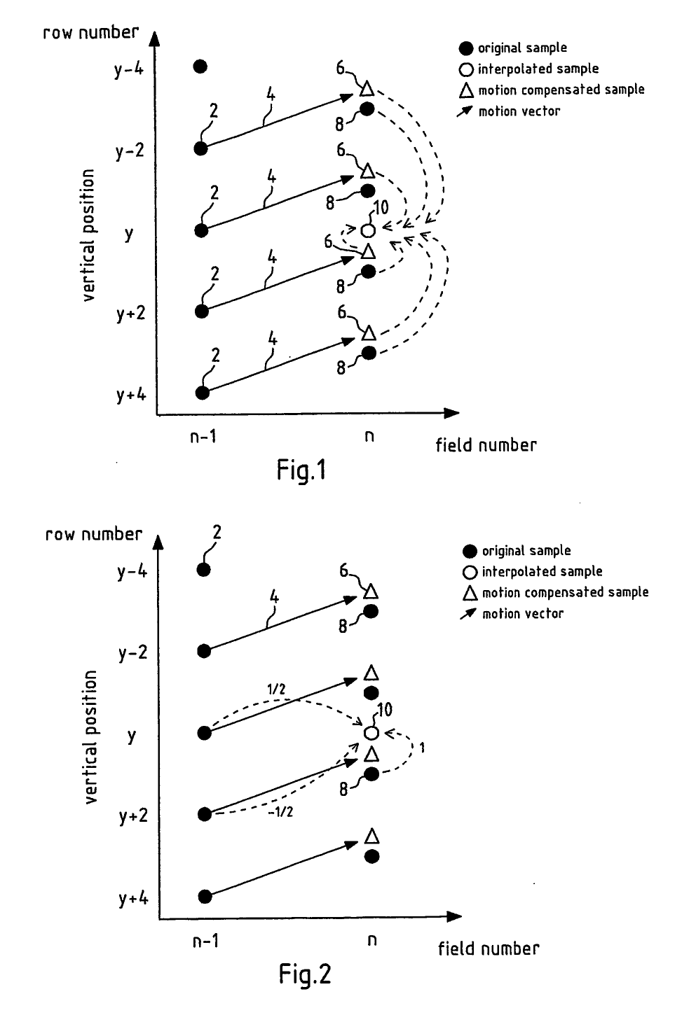

The disclosed method is also known as the general sampling theorem (GST) de-interlacing method. The method is depicted in FIG. 1. FIG. 1 depicts a field of pixels 2 in a vertical line on even vertical positions y+4−y−4 in a temporal succession of n−1−n. For de-interlacing, two independent sets of pixel samples are required. The first set of independent pixel samples is created by shifting the pixels 2 from the previous field n−1 over a motion vector 4 towards a current temporal instance n into motion compensated pixel samples 6. The second set of pixels 8 is also located on odd vertical lines y+3−y−3. Unless the motion vector 6 is small enough, e.g. unless a so-called “critical velocity” occurs, i.e. a velocity leading to an odd integer pixel displacements between two successive fields of pixels, the pixel samples 6 and the pixels 8 are assumed to be independent. By weighting the pixel samples 6 and the pixels 8 from the current field the output pixel sample 10 results as a weighted sum (GST-filter) of samples.

Mathematically, the output sample pixel 10 can be described as follows. Using F( x̅,n) for the luminance value of a pixel at position x̅ in image number n, and using Fᵢ for the luminance value of interpolated pixels at the missing line (e.g. the odd line) the output of the GST de-interlacing method is as:

$$\begin{matrix}{F}_{i} ( {x}^{->} , n ) = {\sum }_{k} F ( {x}^{->} - ( 2 k + 1 ) {{u}^{->}}_{y} , n ) {h}_{1} ( k , {δ}_{y} ) + \\ {\sum }_{m} F ( {x}^{->} - {e}^{->} ( {x}^{->} , n ) - 2 m {{u}^{->}}_{y} , n - 1 ) {h}_{2} ( m , {δ}_{y} )\end{matrix}$$

with h₁ and h₂ defining the GST-filter coefficients. The first term represents the current field n and the second term represents the previous field n−1. The motion vector e̅( x̅,n) is defined as:

$${e}^{->} ( {x}^{->} , n ) = ( \begin{matrix}{d}_{x} ( {x}^{->} , n ) \\ 2 Round ( \frac{{d}_{y} ( {x}^{->} , n )}{2} )\end{matrix} )$$

with Round () rounding to the nearest integer value and the vertical motion fraction δ_{y} defined by:

$${δ}_{y} ( {x}^{->} , n ) = \vert {d}_{y} ( {x}^{->} , n ) - 2 Round ( \frac{{d}_{y} ( {x}^{->} , n )}{2} ) \vert$$

The GST-filter, composed of the linear GST-filters h₁ and h₂, depends on the vertical motion fraction δ_{y} ( x̅,n) and on the sub-pixel interpolator type.

Delonge proposed to just use vertical interpolators and thus use interpolation only in the y-direction. If a progressive image F^{p} is available, F^{e} for the even lines could be determined from the luminance values of the odd lines F^{o} as:

$$\begin{matrix}{F}^{e} ( z , n ) = {( {F}^{p} ( z , n - 1 ) H ( z ) )}_{e} \\ = {F}^{o} ( z , n - 1 ) {H}^{o} ( z ) + {F}^{e} ( z , n - 1 ) {H}^{e} ( z )\end{matrix}$$

in the z-domain where F^{e} is the even image and F^{o} is the odd image. Then F^{o} can be rewritten as:

$${F}^{o} ( z , n - 1 ) = \frac{{F}^{o} ( z , n ) - {F}^{e} ( z , n - 1 ) {H}^{o} ( z )}{{H}^{e} ( z )}$$

which results in:
F^{e}(z,n)=H₁(z)F^{o}(z,n)+H₂(z)F^{e}(z,n−1)
The linear interpolators can be written as:

$${H}_{1} ( z ) = \frac{{H}^{o ( z )}}{{H}^{e ( z )}}$$

When using sinc-waveform interpolators for deriving the filter coefficients, the linear interpolators H₁(z) and H₂(z) may be written in the k-domain:

$${h}_{1} ( k ) = {( - 1 )}^{k} sin c ( π ( k - \frac{1}{2} ) ) \frac{sin ( {πδ}_{y} )}{cos ( {πδ}_{y} )}$$

$${h}_{2} ( k ) = {( - 1 )}^{k} \frac{sin c ( π ( k + {δ}_{y} ) )}{cos ( {πδ}_{y} )}$$

When using a first-order linear interpolator, a GST-filter has three taps. The interpolator uses two neighboring pixels on the frame grid. The derivation of the filter coefficients is done by shifting the samples from the previous temporal frame to the current temporal frame. As such, the region of linearity for a first-order linear interpolator starts at the position of the motion compensated sample. When centering the region of linearity to the center of the nearest original and motion compensated sample, the resulting GST-filters may have four taps. Thus, the robustness of the GST-filter is increased.

However, current GST-filters do not take into account any pixels situated in the horizontal direction. Only pixels in the vertical vicinity of the samples pixel and from a temporal previous field, e.g. motion compensated, are used for interpolating the pixel samples.

It is therefore an object of the invention, to provide a de-interpolator which is more robust. It is a further object of the invention, to provide a de-interpolator which provides more exact pixel samples.

The inventions solves these objects by providing a method for de-interlacing a video signal, wherein at least a first pixel from said current field of input pixels is weighted depending on a horizontal component of said estimated motion vector for calculating said interpolated output pixel.

The combination of the horizontal interpolation with the GST vertical interpolation in a 2-D inseparable GST-filter results in a more robust interpolator. As video signals are functions of time and two spatial directions, the de-interlacing which treats both spatial directions results in a better interpolation. The image quality is improved. The distribution of pixels used in the interpolation is more compact than in the vertical only interpolation. That means pixels used for interpolation are located spatially closer to the interpolated pixels. The area pixels are recruited from for interpolation may be smaller. The price-performance ratio of the interpolator is improved by using a GST-based de-interlacing using both horizontally and vertically neighboring pixels.

A motion vector may be derived from motion components of pixels within the video signal. The motion vector represents the direction of motion of pixels within the video image. A current field of input pixels may be a set of pixels, which are temporal currently displayed or received within the video signal. A weighted sum of input pixels may be acquired by weighting the luminance or chrominance values of the input pixels according to interpolation parameters.

Performing interpolation in the horizontal direction may lead, in combination with vertical GST-filter interpolation, to a 10-taps filter. This may be referred to as a 1-D GST, 4-taps interpolator, the four referring to the vertical GST-filter only. The region of linearity, as described above, may be defined for vertical and horizontal interpolation by a 2-D region of linearity. Mathematically, this may be done by finding a reciprocal lattice of the frequency spectrum, which can be formulated with a simple equation:
f̅x=1
where f̅=(fₕ,fᵥ) is the frequency in the x̅=(x,y) direction. The region of linearity is a square which has the diagonal equal to one pixel size. In the 2-D situation, the position of the lattice may be freely shifted in the horizontal direction. The centers of triangular-wave interpolators may be at the positions x+p+δₓ in the horizontal direction, with p an arbitrary integer. By shifting the 2-D region of linearity, the aperture of the GST-filter in the horizontal direction may be increased. By shifting the vertical coordinate of the center of the triangular-wave interpolators by y+m, an interpolator with 5-taps may be realized. The sampled pixel may be expressed by:

$$\begin{matrix}P ( x , y , n ) = \frac{{δ}_{y} \vert {δ}_{x} \vert ( 1 - \vert {δ}_{x} \vert ) A ( x - 1 , y + sign ( {δ}_{y} ) , n )}{1 - {δ}_{y}} - \\ \frac{{δ}_{y} ( {\vert {δ}_{x} \vert}^{2} + {( 1 - \vert {δ}_{x} \vert )}^{2} ) A ( x , y + sign ( {δ}_{y} ) , n )}{1 - {δ}_{y}} - \\ \frac{{δ}_{y} \vert {δ}_{x} \vert ( 1 - \vert {δ}_{x} \vert ) A ( x + 1 , y + sign ( {δ}_{y} ) , n )}{1 - {δ}_{y}} + \\ \frac{\begin{matrix}( 1 - \vert {δ}_{x} \vert ) C ( x + {δ}_{x} , y + {δ}_{y} , n \pm 1 ) + \\ \vert {δ}_{x} \vert C ( x + {δ}_{x} + sign ( {δ}_{x} ) , y + {δ}_{y} , n \pm 1 )\end{matrix}}{1 - {δ}_{y}}\end{matrix}$$

with A and C being pixels contributing to the sampled pixel.

A method of claim 2 may increase the robustness of the interpolator. Horizontally neighboring pixels may also contribute to the sampled pixel. The interpolation then also depends on horizontally neighboring pixels.

A method of claim 3 results in using pixels which are not within the 2-D region of linearity. Thus, the sampled pixel also depends on pixel values which are spatially located apart from the sampled pixel.

According to a method of claim 4, a previous field of input pixels is defined, which means that a temporal previous image is used for defining input pixels. The input pixels of the previous field may be motion compensated by using the motion vector. According to claim 4 the pixel being closest to the sampled pixel when motion compensated is used for calculating the sampled output pixel.

According to claim 5, horizontally neighboring vertical lines may be used for calculating the sampled output pixel. Thus, also a vertical component is used for the sampled output pixel.

The sign and the absolute value of the motion vector may be used according to claim 6 and 7.

According to claim 8, where input pixels of a previous field, a next field and a current field are used to calculate first, second and third output pixels and where the final output pixel is calculated based on a weighted sum of these output pixels, temporally and spatially neighboring pixels may be used for calculating the sampled output pixel. This increases the robustness of the de-interlacing.

A method according to claim 9 allows for using a special relationship between input pixels which are temporally separated by a current pixel.

Another aspect of the invention is a display device for displaying a de-interlaced video signal comprising estimation means for estimating a motion vector of pixels, definition means for defining a current field of input pixels from said video signal to be used for calculating an interpolated output pixel, calculation means for calculating an interpolated output pixel from a weighted sum of said input pixels and weighting means for weighting at least a first pixel from said current field of input pixels depending on a horizontal component of said estimated motion vector for calculating said interpolated output pixel.

Another aspect of the invention is a computer program for de-interlacing a video signal operable to cause a processor to estimate a motion vector for pixels from said video signal, define a current field of input pixels from said video signal to be used for calculating an interpolated output pixel, calculate an interpolated output pixel from a weighted sum of said input pixels, and weight at least a first pixel from said current field of input pixels depending on a horizontal component of said estimated motion vector for calculating said interpolated output pixel.

These and other aspects of the invention will be apparent from and elucidated with reference to the embodiments described hereinafter:

FIG. 1 depicts an interpolation according to GST-de-interlacing;

FIG. 2 depicts a first-order linear interpolating;

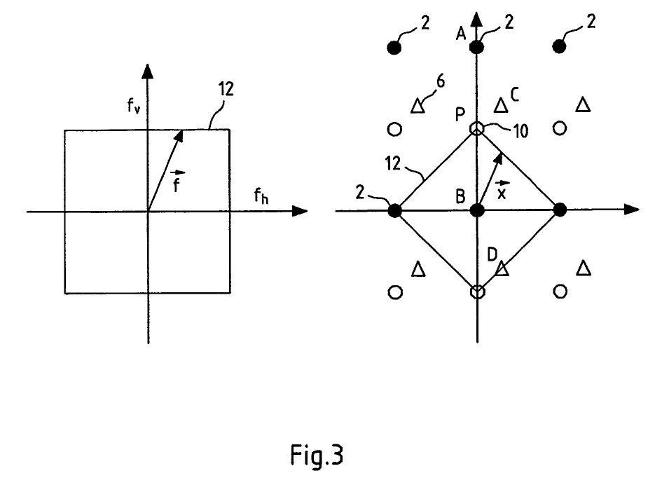

FIG. 3 depicts a region of linearity;

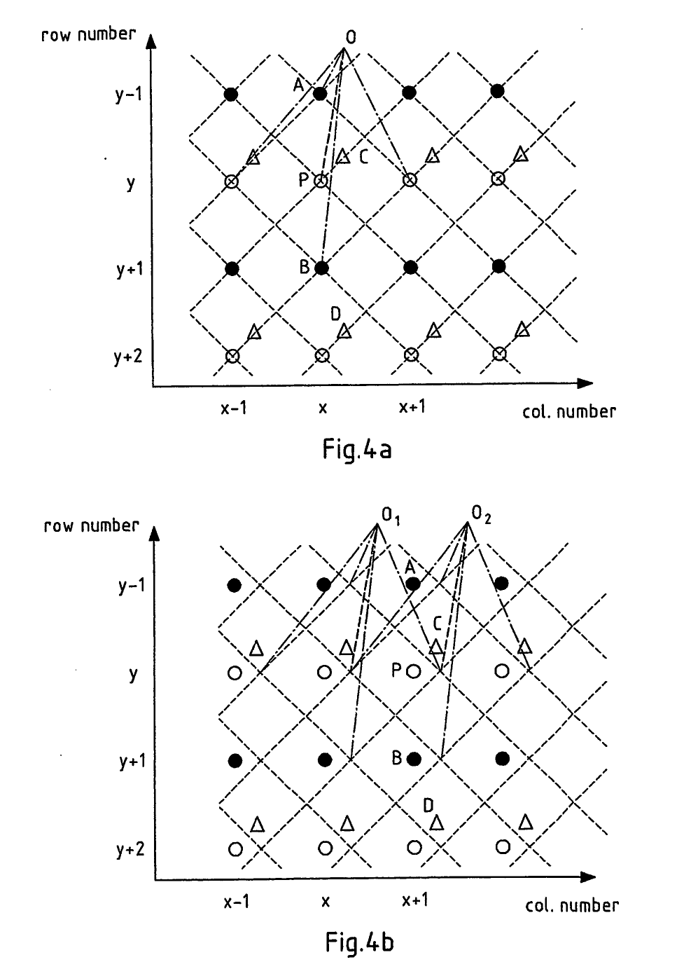

FIG. 4 depicts a position of a region of linearity for an inventive interpolator with horizontal contribution of pixels to the output pixel;

FIG. 5 depicts diagrammatically an inventive method;

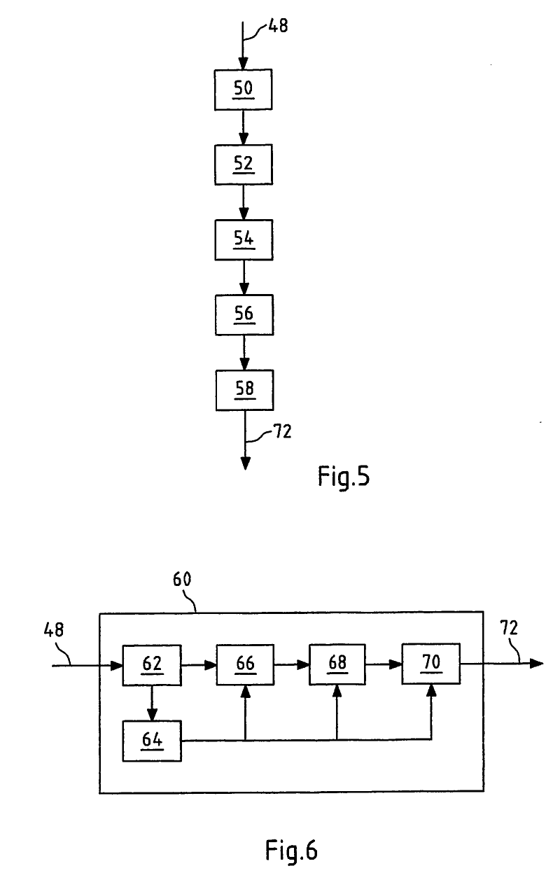

FIG. 6 depicts an inventive display device.

FIG. 2 depicts the result of a first-order linear interpolator, wherein like numerals as in FIG. 1 depict like elements. As the interpolated sample pixel 10 is a weighted sum of neighboring pixels, the weight of each pixel should be calculated by the interpolator. In case a first-order linear interpolator H(z)=(1−δ_{y})+δ_{y}z⁻¹ with 0≦δ_{y}≦1 the interpolators H₁(z) and H₂(z) may be given as:

$${H}_{1} ( z ) = \frac{{δ}_{y}}{1 - {δ}_{y}} {z}^{- 1}$$

$${H}_{2} ( z ) = ( 1 - {δ}_{y} ) - \frac{{( {δ}_{y} )}^{2}}{1 - {δ}_{y}} {z}^{- 2}$$

The motion vector may be relevant for the weighting of each pixel. In case a motion of 0.5 pixel per field, i.e. δ_{y}=0.5, is given, the inverse z-transform of even field F^{e}(z,n) results in the spatio-temporal expression for F^{e}(y,n):

$${F}^{e} ( y , n ) = {F}^{o} ( y + 1 , n ) + \frac{1}{2} {F}^{e} ( y , n - 1 ) - \frac{1}{2} {F}^{e} ( y + 2 , n - 1 )$$

As can be seen from FIG. 2, the neighboring pixels of the previous field n−1 are weighted with 0.5 and the neighboring pixel of the current field n is weighted with 1. The first-order linear interpolator as depicted in FIG. 2 results in a three taps GST-filter. The above calculation assumes linearity between two neighboring pixels on the frame grid. In case the region of linearity is centered to the center of the nearest original and motion compensated sample, the resulting GST-filter may have four taps. The additional tap in these four taps GST-filters increases the contribution of spatially neighboring sample values. Two sets of independent samples from the current field and from previous/next temporal fields, shifted over the motion vector, may be used for GST-filtering only in the vertical direction according the prior art. As the interpolator can only be used on a so-called region of linearity, which has the size of one pixel, the number of taps depends on where the region of linearity is located. This means that up to four neighboring pixels in the vertical direction may be used for interpolation.

As the more pixels are used, the better results are obtained, it should be possible to use more pixels. This may be done by using pixels situated in the horizontal vicinity of the sampled pixel. When using pixels shifted in the horizontal direction, an average value may be used for interpolation, which is:
Cₐᵥ(z,y+δ_{y},n±1)=(1−|δₓ|)C(x+δₓ,y+δ_{y},n±1) +|δₓ|C(x+sign(δₓ)+δₓ,y+δ_{y},n±1)
The ±-sign refers to whether the previous or the next field is used in the interpolation. The combination of such a horizontal interpolation with a vertical GST-filter interpolation allows using a separable 10-taps filter.

To use both pixels in the vertical and horizontal direction, the region of linearity has to be chosen accordingly. In particular in video signals, these are function of time and two spatial directions. Therefore, it is possible to define a de-interlacing algorithm that treats both spatial directions equally.

In case taking horizontally and vertically neighboring pixels into account, the region of linearity may be defied as a grid defining a 2-D region of linearity. This 2-D region of linearity may be found within a reciprocal lattice of the frequency spectrum.

FIG. 3 depicts a reciprocal lattice 12 in the frequency domain and the spatial domain, respectively. The lattice 12 defines the region of linearity which is now a parallelogram. A linear relation is established between pixels separated by a distance | x̅| in the x̅ direction. Further, the triangular interpolator used in the 1-dimensional interpolator may take the shape of a pyramidal interpolator. Shifting the region of linearity in the vertical or horizontal direction leads to different numbers of filter taps. In particular, if the pyramidal interpolators are centered at position (x+p, y), with p an arbitrary integer the 1-D case may result.

In the 2-D situation, the position of the lattice 12 in the horizontal direction may be freely shifted. The simplest shifting may result in centering the pyramids at the position x+p+δₓ in the horizontal direction, with p an arbitrary integer. This leads to a larger aperture of the GST-filter in the horizontal direction. In case the vertical coordinate of the center of the pyramidal interpolator is y+m, a five-taps interpolator may be obtained. The sampled pixel may be expressed by:

$$P ( x , y , n , ) = - \frac{{δ}_{y} \vert {δ}_{x} \vert ( 1 - \vert {δ}_{x} \vert ) A ( x - 1 , y + sign ( {δ}_{y} ) , n )}{1 - {δ}_{y}} - \frac{{δ}_{y} ( {\vert {δ}_{x} \vert}^{2} + {( 1 - \vert {δ}_{x} \vert )}^{2} ) A ( x , y + sign ( {δ}_{y} ) , n )}{1 - {δ}_{y}} - \frac{{δ}_{y} \vert {δ}_{x} \vert ( 1 - \vert {δ}_{x} \vert ) A ( x + 1 , y + sign ( {δ}_{y} ) , n )}{1 - {δ}_{y}} + \frac{{C}_{av} ( x + {δ}_{x} , y + {δ}_{y} , n \pm 1 )}{1 - {δ}_{y}}$$

It may be possible, as depicted in FIG. 4, to interpolate pixels which are symmetrically situated to the pixel P(x,y,n). These pixel may be, as depicted in FIG. 4a, B(x−1,y−sign(δ_{y}),n), B(x,y−sign(δ_{y}),n) and B(x+1,y−sign(δ_{y}),n) from the current field. Further from the previous and the next field may be taken D(x+δₓ,y−2sign(δ_{y})+δ_{y},n±1), D(x+sign(δₓ)+δₓ,y−2sign(δₓ)+δ_{y})+δ_{y}n±1). As depicted in FIG. 4a, a five-taps interpolator takes into account the above-mentioned pixel values. When shifting the region of linearity in direction of the motion vector, a further value C(x+δₓ,y+δ_{y},n±1) may be used.

According to the invention, the region of pixels contributing to the interpolation is extended in the horizontal direction. The interpolation results are improved in particular for sequences with a diagonal motion.

FIG. 5 depicts a method according to the invention. In step 50 a motion vector is estimated from an input video signal 48. The input video signal 48 is divided up in regions of linearity in step 52 for a current field, a previous field and a next field. After that, in step 54, horizontally neighboring pixels as well as motion compensated pixels using a horizontal component of the motion vector are weighted according to the motion vector. In step 56, vertically relevant pixels are weighted according to the motion vector.

In step 58, the weighted pixel values are summed and interpolated, resulting in an interpolated pixel sample. This interpolated pixel sample may be used for creating an odd line of pixels when only even lines of pixels are transmitted within the video signal 48. The image quality may be increased.

FIG. 6 depicts a display device 60. An input video signal 48 is fed to said display device 60 and received within a receiver 62. The receiver 62 provides the received images to storage 64. In motion estimator 66, motion vectors are estimated from the video signals. Pixels from the current, the previous and the next field are taken from the storage 64 and weighted in the weighting means 68, in particular according to the estimated motion vector. The weighted pixel values are provided to summer 70, where a weighted sum is calculated. The resulting value is fed to output 72.

With the inventive method, computer program and display device the image quality may be increased without increasing transmission bandwidth. This is in particular relevant when display devices are able to provide higher resolution than transmission bandwidth is available.

1. Method for de-interlacing, in particular GST-based de-interlacing a video signal with:
estimating a motion vector for pixels from said video signal,
defining a current field of input pixels from said video signal to be used for calculating an interpolated output pixel,
calculating an interpolated output pixel from a weighted sum of input pixels from said video signal, wherein:
at least a first pixel from said current field of input pixels is weighted depending on a horizontal component of said estimated motion vector for calculating said interpolated output pixel.

2. A method of claim 1, wherein at least one horizontally neighboring pixel from a single line from said current field of input pixels neighboring said output pixel is weighted for calculating said output pixel.

3. A method of claim 1, wherein at least one additional pixel from a field of input pixels neighboring said current field is weighted for calculating said output pixel.

4. A method of claim 1, wherein a previous field of input pixels is defined and wherein an additional pixel appearing closest to said output pixel when motion compensating said previous field with an integer part of said motion vector is weighted for calculating said output pixel.

5. A method of claim 1, wherein at least three horizontally neighboring pixels from each of two lines in said current field neighboring said output pixel are weighted for calculating said output pixel, respectively.

6. A method of claim 1, wherein said weighting of pixels depends on a fractional part of said motion vector.

7. A method of claim 1, wherein said weighting of pixels depends on a sign of said motion vector.

8. A method for de-interlacing a video signal, wherein:
a first output pixel is calculated based on at least one pixel from a current field according to claim 1,
a previous field of input pixels is defined and wherein a second output pixel is calculated based on at least one pixel from said current field and at least one pixel from said previous field,
a next field of input pixels is defined and wherein a third output pixel is calculated based on at least one pixel from said current field and at least one pixel from said next field, and
said output pixel is calculated based on a weighted sum of said first output pixel, said second output pixel and said third output pixel.

9. A method according to claim 8, wherein said output pixel is calculated based on the relationship between said second output pixel and said third output pixel.

10. Display device for displaying a de-interlaced video signal comprising:
estimation means for estimating a motion vector of pixels,
definition means for defining a current field of input pixels from said video signal to be used for calculating an interpolated output pixel,
calculation means for calculating an interpolated output pixel from a weighted sum of said input pixels, and
weighting means for weighting at least a first pixel from said current field of input pixels depending on a horizontal component of said estimated motion vector for calculating said interpolated output pixel.

11. Computer program for de-interlacing a video signal operable to cause a processor to:
estimate a motion vector for pixels from said video signal,
define a current field of input pixels from said video signal to be used for calculating an interpolated output pixel,
calculate an interpolated output pixel from a weighted sum of said input pixels, and
weight at least a first pixel from said current field of input pixels depending on a horizontal component of said estimated motion vector for calculating said interpolated output pixel.
